(19) United States
(12) Patent Application Publication
(10) Pub. No.: US 2024/0253498 A1
(43) Pub. Date: Aug. 1, 2024

(54) Charging post comprising a cable holder for the charging cable

(71) Applicant: ads-tec Energy GmbH, Nürtingen (DE)

(72) Inventors: Thomas SPEIDEL, Markgröningen (DE); Andreas GREIF, Weilheim/Teck (DE)

(73) Assignee: ads-tec Energy GmbH, Nürtingen (DE)

(21) Appl. No.: 18/565,959

(22) PCT Filed: May 24, 2022
(86) PCT No.: PCT/EP2022/064114

§ 371 Date: Nov. 30, 2023

(30) Foreign Application Priority Data
Jun. 2, 2021 (EP) 21177492.2

(51) Int. Cl. B60L 53/31; B60L 53/18

(52) U.S. Cl. CPC B60L 53/31; B60L 53/18

(57) ABSTRACT

A charging post (1) includes a charging cable (2) for connection to a mobile energy storage system. The charging cable (2) is guided out of the housing (3) of the charging post (1) via at least one cable outlet (5) and ends with a charging plug (4). The housing (3) has a support (10) for a cable holder (20), which support is held about an upright pivot axis (11). The cable outlet (5) is provided on the front housing wall (19), on an outer wall (13, 14) or on the rear wall (15) of the housing (3). The cable outlet (5) is positioned with an outlet opening (23) facing the plane (33) of the roof section (8) of the charging post (1), wherein the cable outlet (5) is designed as a support (10) for the cable holder (20).

### CROSS-REFERENCE TO RELATED APPLICATION

This application is a national stage application, filed under 35 U.S.C. § 371, of International Patent Application PCT/EP2022/064114, filed on May 24, 2022, which claims the benefit of European Patent Application EP 21177492.2, filed on Jun. 2, 2021.

### BACKGROUND

Charging posts for electric vehicles typically stand with a pedestal section on a foundation. A cable outlet on a side surface of the charging post is oriented in the direction of the pedestal section. Thus, the charging cable guided out of the housing of the charging post initially runs downwards from the cable outlet in the direction of a base, and the charging plug is held in a receptacle in the housing approximately halfway up the charging post in a parking position.

If a user drives up to the charging post with an electrically powered vehicle, they must ensure that the charging socket on the vehicle is oriented towards the charging post, in order to be able to plug the charging plug into the charging socket after it has been removed from the receptacle of the housing. The distance between the vehicle and the charging post is bridged by the flexible charging cable, which usually rests on the ground and gets dirty.

If the charging socket of the vehicle is facing away from the charging post, the charging cable must be guided around the vehicle or over the vehicle roof. This is only possible with correspondingly long charging cables. A long charging cable means that if the distance between the charging post and the charging socket on the vehicle is short, a significant section of the charging cable will rest on the ground.

It is known from JP2012010561A to attach a charging device to the side of a power distribution box. The charging device has a rigid tube that projects above the power distribution box to a desired height and serves to guide the charging cable. At the upper end of the rigid tube, the charging cable is guided downwards via a pivoting 180° curve and ends with a charging plug, which is parked in a receptacle of the charging device. The structure of the charging device requires a considerable amount of installation space, wherein, due to the lateral attachment of the charging device to the power distribution box, access to the charging device from both sides is only possible under difficult spatial conditions.

US 2013/0257373 A1 describes a charging device with which the charging cable is guided in a mast that can be pivoted about a horizontal axis in a similar way to a barrier. Use of the charging post is possible if the vehicle is parked at the front of the charging device. Vehicles parked to the side of the charging device must grasp the freely swinging charging plug and plug it into the charging socket of the vehicle, wherein the mast pivots downwards when the charging cable is pulled. Thereby, the charging cable can inevitably come to rest on the vehicle roof, which is undesirable.

### SUMMARY

The disclosure relates to a charging post comprising a charging cable for connection to a mobile energy storage system. The charging post has a housing from which the charging cable is guided out via a cable outlet and ends with a charging plug.

The charging post provides a solution that allows keeping the orientation of the vehicle to be charged to the charging post variable and, while ensuring a long range by means of a long charging cable, at the same time ensures that, in a parking position at the charging post and/or in an operating position, the risk of the charging cable resting on the ground is reduced, and nevertheless the charging post is compact and has a low space requirement.

This is achieved in that a support for a cable holder is arranged on the housing of the charging post, wherein the cable holder is held on the support so as to be pivotable about an upright pivot axis. At least one cable outlet is provided on the front housing wall, on an outer wall or on the rear wall of the housing and is positioned with an outlet opening facing the plane of the roof section of the charging post. The cable holder has a length that is less than the length of the charging cable extending from the cable outlet to the charging plug. The charging cable is forcibly guided through the cable holder in a charging cable section from the cable outlet to the end of the cable holder. The cable outlet itself is designed as a support for the cable holder. Thus, the charging cable exiting the cable outlet can be received directly by the cable holder.

In particular, the charging post stands vertically on a base, a foundation or a similar surface. The cable holder held on the charging post has a first end and a second end. The first end of the cable holder is held in a manner pivotable about the upright pivot axis of the support held on the charging post. The upright pivot axis is a substantially vertically oriented axis, preferably a vertical axis. In relation to the contact surface of the charging post, its vertical axis is a perpendicular axis. The upright pivot axis is preferably parallel to the vertical axis of the charging post.

In one design, the cable holder has a curved shape, in particular a slightly curved shape along its length. The height of the curve is significantly less than the length of the curve. The opening of the curve is positioned facing the contact surface of the charging post. In particular, the cable holder has a C-shape along its length. In a particular design, the curve of the cable holder is designed in such a manner that, when the cable holder is in the parking position, the opening of the curve is positioned facing the roof section of the housing of the charging post. The opening width of the curve between the first end of the cable holder and its second end is greater than the distance between the rear wall and the front wall of the housing. Preferably, the opening width of the curve can correspond to the diagonal of the roof section.

The cable holder is preferably a rigid cable tube. The charging cable extends from the cable outlet through the support into the first end of the cable tube and exits at the second end of the cable tube. The cable tube is expediently closed over its entire circumference, such that the charging cable runs in a closed guiding channel from the cable outlet to the second end of the cable tube. The cable tube can be made of plastic, a cast alloy, a metal or similar material. Regardless of the material used, the cable tube has a greater stiffness than the charging cable itself. The charging cable is advantageously stiffened by the cable tube in the charging cable section between the cable outlet and the end of the cable tube. Materials such as fiberglass-reinforced plastic, metal or the like are suitable for a rigid cable tube. In particular, it is provided that the inner diameter of the cable tube is designed to be larger than the outer diameter of the charging cable. Thus, the charging cable can be guided in the cable tube with clearance. In particular, the charging cable is positioned in the cable tube with radial clearance.

The charging post has a pedestal section resting on a contact surface and a roof section at a distance from the pedestal section. The cable outlet with the support is positioned closer to the roof section than to the pedestal section of the housing. In particular, the cable outlet is positioned a short distance from the roof section. The cable outlet has an outlet opening. The outlet opening is oriented in such a manner that it is positioned facing the roof section, i.e., the plane of the roof section of the charging post. The charging cable exits the cable outlet in an upward direction, preferably upwards in the direction of the plane of the roof section.

The charging cable is guided at the first end of the cable holder, in particular the cable tube, coming out of the outlet opening of the cable outlet, initially in an upward direction and then—following the curved shape of the cable holder—is deflected in a forcibly guided manner in the direction of the pedestal section of the charging post. The upright section of the charging cable that runs upwards to the plane of the roof section of the charging post is positioned on the pivot axis of the support.

In a first embodiment, the cable outlet with the support for the cable holder is positioned on the longitudinal center axis of a side wall of the housing. The longitudinal center axis of the side wall is preferably parallel to the vertical axis of the housing of the charging post, which is perpendicular in particular. Based on the pivotability of the cable holder about the upright, in particular vertical, pivot axis of the support, the charging cable has the same range on both sides of the charging post. The cable outlet is oriented with its outlet opening towards the plane of the roof section.

In a further embodiment, the cable outlet with the support for the cable holder is positioned in an upper corner of a housing wall of the housing. The term “enclosure walls” refers to the outer walls, the front wall and the rear wall. The cable outlet is oriented with its outlet opening towards the roof section/the plane of the roof section. Based on the arrangement in an upper corner of the housing wall, the upright pivot axis is closer to a first lateral outer wall than to a second lateral outer wall. The lateral outer walls are positioned parallel to one another. The arrangement ensures a greater range for the charging cable in the region of the first lateral outer wall than on the other, second lateral outer wall.

Advantageously, the position of the cable outlet with the upright pivot axis is provided in such a manner that the cable holder, in particular a cable tube, can be pivoted by at least a quarter circle of 90°. In some embodiments, the cable holder can be pivoted by up to 180° about the upright axis of the support at the cable outlet. In advantageous embodiments, a pivot angle of almost 360° can be achieved.

If only one cable outlet for a charging cable is provided on a housing wall of the charging post, preferably a front or rear wall of the charging post, and only one cable holder pivotable about an upright axis is arranged, this can be pivoted by at least 180° about the upright pivot axis.

If two cable outlets with two cable holders are arranged on a housing wall of the charging post, preferably on a front wall or a rear wall of the charging post, which in each case can be pivoted about an upright pivot axis, the angle of rotation of the cable holders depends on the respective operating position of the other cable holder. If a charging cable is positioned in its parking position, in which the cable holder is expediently positioned against the housing wall of the charging post, a second cable holder with a charging cable can be pivoted by up to 180º. If both cable holders are in an operating position, the pivot range of one cable holder depends on the operating position of the other cable holder. In any case, it is ensured that the charging plug of a charging cable can be plugged into a charging socket of a mobile energy storage system within a circumferential range of at least 180° about the front wall and/or the rear wall of the charging post.

In a preferred further development, it is provided that each cable holder has a parking position and a plurality of operating positions. Thereby, the arrangement can be such that the cable holder does not protrude beyond the outer walls of the housing in the parking position. The outer walls of the housing are the side surfaces of the charging post, which laterally delimit the charging post and adjoin the housing wall of the housing having the cable outlet, in particular the front wall and/or the rear wall of the housing.

It can also be advantageous to have a design with which, in the operating positions of the cable holder, they do not protrude beyond the outer walls of the housing of the charging post.

In a particular design, it is provided that the cable holder has a parking position and a plurality of operating positions. When the cable holder is in the parking position, it extends over the roof section of the housing. The length of the cable holder between its first end and its second end is greater than the distance between the rear wall and the front wall of the housing. Thereby, the cable holder extending over the roof section does not protrude beyond the outer walls of the housing of the charging post. Such structure of the charging post ensures easy operation and good accessibility while taking up little space.

Advantageously, the structure is provided such that the cable outlet is designed with the support on the rear wall of the housing. The first end of the cable holder is held on the support in the region of the rear wall so that it can rotate about the upright pivot axis. In a parking position, the cable holder is preferably parallel to a plane defined by the outer wall. In a parking position of the cable holder, the second end of the cable holder is positioned in a region in front of the plane of the front wall of the housing. Expediently, the second end of the cable holder ends at the plane of the roof section. The length of the cable holder between its first end and its second end can expediently correspond to the diagonal of the roof section. This creates good accessibility to the charging plug. The cable holder can be pivoted up to 360º.

The cable holder has a first end at a first height level and a second end at a second height level. In one design, the first height level of the first end on the rear wall of the housing is lower than the second height level of the second end in the region of the front wall.

It can be advantageous if the cable holder is configured such that its first end is positioned at a first height level. Another, second end of the cable holder is positioned at a second height level. In another design, the cable holder is arranged on the charging post in such a manner that the first end is positioned at a higher height level than the second end. This means that the first end at the first height level is at a greater distance from the contact surface of the charging post than the second end at the second height level.

A plurality of cable outlets, in particular two cable outlets, can be expediently provided on a housing wall of the charging post, in particular on the front wall and/or the rear wall of the charging post. In particular, the plurality of cable outlets on a housing wall of the charging post are positioned at a common height level.

With the arrangement of the plurality of cable outlets with cable holders on one housing wall of the charging post, it can be advantageous for the cable holders to overlap one another in their parking positions.

Advantageously, the length of the cable holder is designed in such a manner that the charging cable section that is forcibly guided and stiffened by the cable holder is 20% to 70%, in particular 50%, of the total length of the charging cable extending between the cable outlet and the charging plug. The remaining free length of the charging cable, which is not fixed by the cable holder, enables a flexible guiding of the charging cable to a charging socket on the mobile energy storage system.

It can be expedient to design the support at the cable outlet as a swivel joint. The support and the cable outlet can expediently be designed in one piece. The swivel joint can be firmly connected to the cable holder and/or the support.

Further features of the invention are apparent from the claims, the description and the drawings, in which exemplary embodiments of the invention described in detail below are shown. The features of the claims, the features mentioned in the description along with the features disclosed in the drawings can be combined independently of one another. Thereby, combinations of features that combine features of different exemplary embodiments are also provided.

### BRIEF DESCRIPTION OF THE DRAWINGS

FIG. 1 shows a view of a housing wall of the charging post with a centrally arranged cable holder in a parking position.

FIG. 2 shows a view of the housing wall of the charging post according to FIG. 1 in an operating position.

FIG. 3 shows a perspective view of a charging post with a central cable outlet and a plurality of operating positions.

FIG. 4 shows a top view of the charging post according to FIG. 3 with a schematic representation of the range of the charging cable guided by a cable holder.

FIG. 5 shows a perspective view of a charging post with a cable outlet provided in a corner of a housing wall with a support for a cable holder in a parking position.

FIG. 6 shows a perspective view of a charging post according to FIG. 5 with a cable holder in an operating position.

FIG. 7 shows a perspective representation of a charging post according to FIG. 5 in a further operating position.

FIG. 8 shows a top view of the charging post according to FIG. 5 with a representation of the range of the charging cable guided by a cable holder when the cable outlet is arranged in a corner of the housing wall.

FIG. 9 shows a representation of a charging post with a cable outlet with a cable holder arranged centrally on the front housing wall and with a further cable outlet with a further cable holder arranged centrally on the rear wall.

FIG. 10 shows a representation of a charging post with a cable outlet provided in an upper corner in each case on the front housing wall, each with a cable holder arranged in a parking position.

FIG. 11 shows a perspective representation of a charging post with a cable outlet provided in an upper corner in each case on the front housing wall, and each cable holder arranged in a parking position.

FIG. 12 shows a top view of a charging post according to FIG. 10 or FIG. 11 with a representation of the range of the charging cable.

FIG. 13 shows a front view of a charging post with cable outlets with cable holders arranged next to one another on opposite sides of a longitudinal center axis of the front side in a parking position and with a schematic representation of a user to visualize the proportions.

FIG. 14 shows a perspective representation of the charging post according to FIG. 13 with cable holders in the parking position.

FIG. 15 shows a perspective representation of the charging post according to FIG. 14 with a cable holder in the operating position and a cable holder in the parking position.

FIG. 16 shows a top view of the charging post according to FIG. 13 with a representation of the range of the charging cable.

FIG. 17 shows a perspective view of a charging post with cable outlets arranged next to one another on opposite sides of a longitudinal center axis of the front side with two cable holders in parking position.

FIG. 18 shows a perspective view of the charging post according to FIG. 17 with a charging cable in the operating position and a charging cable in the parking position.

FIG. 19 shows a perspective view of the charging post according to FIG. 17 with two charging cables shown in the operating position.

FIG. 20 shows a top view of the charging post according to FIG. 19 with a representation of the range of the individual charging cable.

FIG. 21 shows a perspective representation of a further charging post with a cable outlet provided in an upper corner in each case on the rear housing wall and each cable holder extending over the roof section in a parking position.

FIG. 22 shows a side view of the further charging post according to FIG. 21 with cable holders in the parking position.

FIG. 23 shows a view of the rear wall of the further charging post according to FIG. 21.

FIG. 24 shows a top view of the roof section of the further charging post according to FIG. 21 with cable holders in the parking position.

FIG. 25 shows a perspective representation of the further charging post according to FIG. 21 with a cable holder pivoted about the support in an operating position.

FIG. 26 shows a top view of the charging post according to FIG. 21 with a representation of the pivot angle to achieve a long range of an individual charging cable.

FIG. 27 shows a schematic section through a cable holder with a charging cable guided in it.

### DETAILED DESCRIPTION

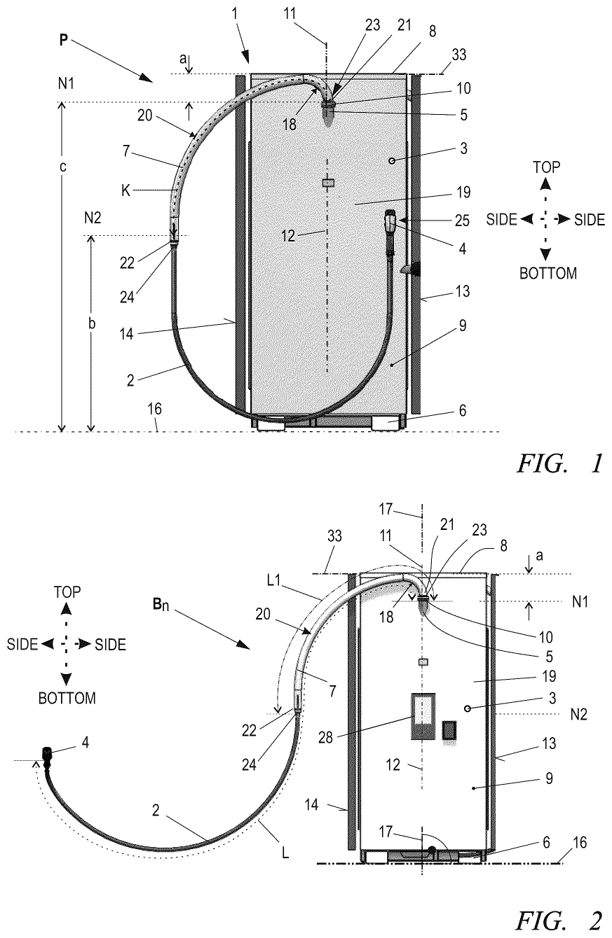

FIG. 1 shows a charging post 1 with a charging cable 2, wherein the charging cable 2 ends with a charging plug 4. The charging post 1 has a housing 3 with a pedestal section 6 and a roof section 8. The housing 3 of the charging post 1 has a front housing wall 19, which is preferably designed as a front wall 9. Further housing walls as outer walls 13 and 14 adjoin the front housing wall 19, in particular on its longitudinal sides, which are substantially at an angle, in particular at a right angle to the front housing wall 19/the front wall 9. The housing 3 is closed off by a rear housing wall, which forms a rear wall 15 (FIG. 3).

The pedestal section 6 of the charging post 1 rests on a base 16. In particular, the base 16 can be designed as a foundation for the charging post 1. The charging post 1 has a vertical axis 17, which is aligned to the base 16, in particular as a vertical or in particular as a perpendicular (FIG. 2).

The housing 3 has a cable outlet 5, which is preferably arranged on the front housing wall 19 of the charging post 1. It can be expedient to design the cable outlet 5 alternatively or additionally on an outer wall 13/14, on the rear wall 15 or in the roof section 8.

In the exemplary embodiment according to FIG. 1 to FIG. 4, the cable outlet 5 is provided near the upper end of the housing 3. The cable outlet 5 is positioned at a distance a below the plane 33 of the roof section 8 in the front housing wall 19. The charging cable 2 is guided out of the housing 3 via the cable outlet 5.

The cable outlet 5 is positioned with its outlet opening 23 facing the plane 33 of the roof section 8 of the charging post 1. The charging cable 2 is guided out of the cable outlet 5 in the direction of the plane of the roof section 8.

The housing 3 of the charging post 1 has a support 10 for a cable holder 20. Advantageously, the cable holder 20 is held on the support 10 so that it can pivot about an upright axis. The upright axis is in particular a pivot axis 11, which is preferably perpendicular to the contact surface of the charging post 1 on the base 16. In an expedient design, the support 10 is provided with a swivel joint. The swivel joint forms the pivot axis 11. It can be expedient to design the support 10 itself as a swivel joint. The support 10 and the cable outlet 5 can expediently be designed in one piece. The swivel joint can be firmly connected to the cable holder 20 and/or the support 10.

The cable holder 20 has a length K. The length K of the cable holder 20 is less than the length L of the charging cable 2 extending from the cable outlet 5 to the charging plug 4. A charging cable section L1 is held by the cable holder 20. The charging cable section L1 of the charging cable 2 is preferably forcibly guided on the cable holder 20. The cable holder 20 itself is expediently designed to be stiff. Due to the stiff cable holder 20, the charging cable section L1, which is forcibly guided on the cable holder 20, is stiffened.

Advantageously, the design is such that the charging cable section L1 forcibly guided on the cable holder 20 is 20% to 70%, in particular 30 to 60%, preferably 50% of the total length L of the charging cable 2 extending between the cable outlet 5 and the charging plug 4. The charging cable section L1, which is forcibly guided on the cable holder 20, is stiffened by the cable holder 20. Thus, the highly flexible charging cable 2 is stiff in the region of the charging cable section L1 due to the cable holder 20. Due to the forced guiding of the charging cable section L1 on the cable holder 20, the flexibility of the charging cable section L1 is restricted. The charging cable section L1 has less flexibility compared to the remaining length of the charging cable section between the end 22 of the cable holder 20 and the charging plug 4.

The arrangement is advantageously provided such that the cable holder 20, which is pivotably held on the support 10, deflects the charging cable 2 in the direction of the pedestal section 6 of the charging post 1. Within the distance a of the outlet opening 23 of the cable outlet 5 to the roof section, the charging cable 2 is deflected in a curve 18 of approximately 90°. The distance a is expediently dimensioned such that the cable holder 20 with the deflected charging cable section advantageously does not protrude beyond the roof section 8 of the charging post 1.

The cable holder 20 has a first end 21 and a second end 22. As shown in particular in FIG. 1, the cable holder 20 has a curved shape over its length K, in particular the cable holder 20 is curved in a C-shape. The arrangement of the cable holder 20 on the charging post 1 can be provided in such a manner that its first end 21, which is pivotably held on the support 10, is positioned at a first height level N1 and its second end 22 is positioned at a second height level N2. In the exemplary embodiment shown, the second height level N2 is lower than the first height level N1. The distance b between the second height level N2 and the base 16 is smaller than the distance c between the first height level N1 and the base 16.

Advantageously, the length L—L1 of the flexible charging cable section of the charging cable 2 extending from the free end 22 of the cable holder 20 to the charging plug 4 is dimensioned such that the charging cable 2 does not touch the base 16, at least in the parking position P. The charging plug 4 of the charging cable 2 is hooked into the plug holder 25, such that the free, flexible charging cable section runs from the charging plug 4 in a U-shaped curve to the end 22 of the cable holder 20. As FIG. 1 shows, contact with the ground of the free charging cable section can be avoided with such an arrangement.

The cable holder 20 is advantageously designed as a cable tube 7, through which the charging cable 2 is guided. The cable tube 7 is provided as a stiff cable tube, in particular as a rigid cable tube 7. The outlet 24 of the cable tube 7 provided at the second end 22 is positioned facing the base 16, on which the charging post 1 stands. The outlet 24 of the cable tube is oriented towards the pedestal section 6 of the charging post 1.

In this and all other exemplary embodiments, the charging cable 2 is advantageously positioned with clearance in the cable tube 7. This is shown by way of example in FIG. 27. The inner diameter Rₖᵢ of the cable tube 20 is larger than the outer diameter R_{La} of the charging cable. A clearance u is advantageously designed between the inner wall of the cable tube 7 and the outer sheath of the charging cable 2.

In the exemplary embodiment according to FIG. 1 to FIG. 4, a control terminal 28 is embedded in the front housing wall 19 of the charging post 1, which is preferably designed as a front wall 9. The charging post 1 is operated by a user via the control terminal 28.

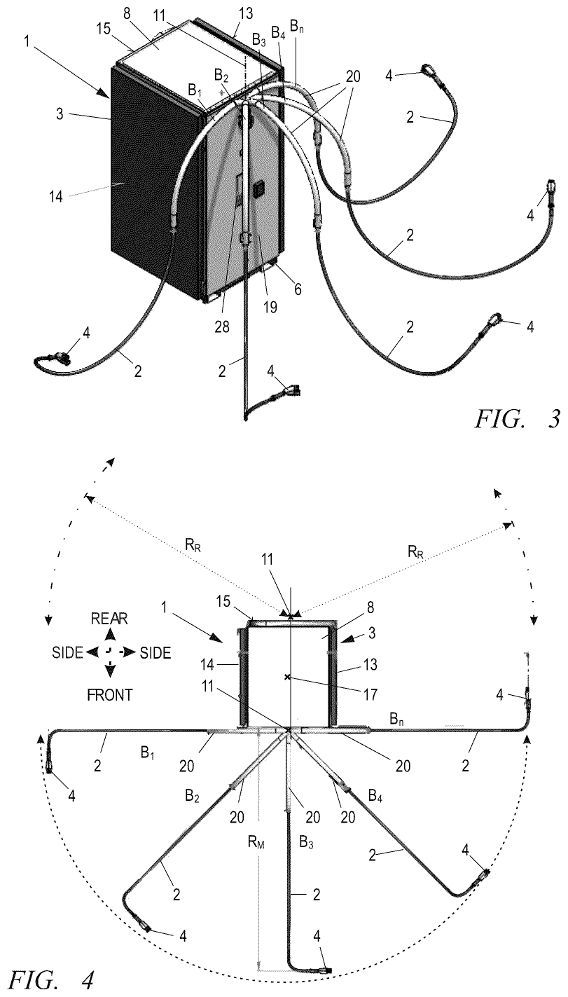

In the exemplary embodiment according to FIG. 1 to FIG. 4, the cable outlet 5 is provided centrally on a housing wall 19 of the charging post 1, in particular on the front housing wall 19, the front wall 9. As shown in FIGS. 1 and 2, the cable outlet 5 is positioned on the longitudinal center axis 12 of the housing wall of the charging post 1. The upright pivot axis 11 is expediently positioned on the longitudinal center axis 12 of the housing wall 19. The cable holder 20, in particular the cable tube 7, ensures on the one hand a forced guiding of the charging cable 2 in a first charging cable section L1 adjoining the cable outlet 5 in a defined height range and, due to the pivotability of the cable holder 20 about the pivot axis 11 by up to at least 180°, ensures a large range of the charging cable while largely avoiding contact with the base 16. The possible operating positions B₁, B₂, B₃, B₄ . . . Bₙ of the cable holder 20 are shown in FIG. 3 and FIG. 4. The charging cable 2/the charging plug 4 can be connected within a semicircle with a radius of Ru to a mobile energy storage system, for example to the charging socket of a motor vehicle. This ensures a high degree of positioning freedom for a vehicle approaching the charging post 1.

In the illustration according to FIG. 1, the cable holder 20 and the charging cable 2 are shown in a parking position P. In the parking position P, the charging plug 4 at the end of the charging cable 2 is held securely in a plug holder 25 of the charging post 1. The plug holder 25 is preferably at the height level N2 of the end 22 of the cable holder 20. In particular, the cable holder 20 ends in the region of one outer wall 14 of the housing 3 of the charging post 1. The plug holder 25 is positioned in the region of the other, opposite outer wall 13 of the housing 3.

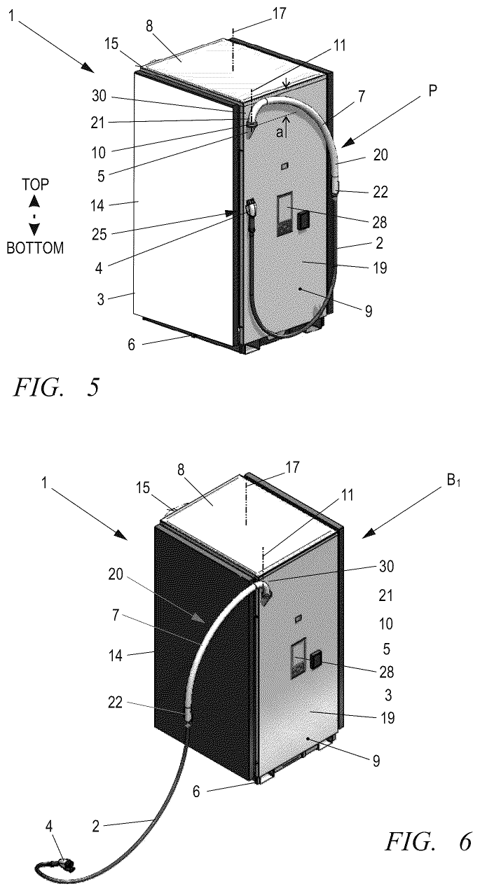

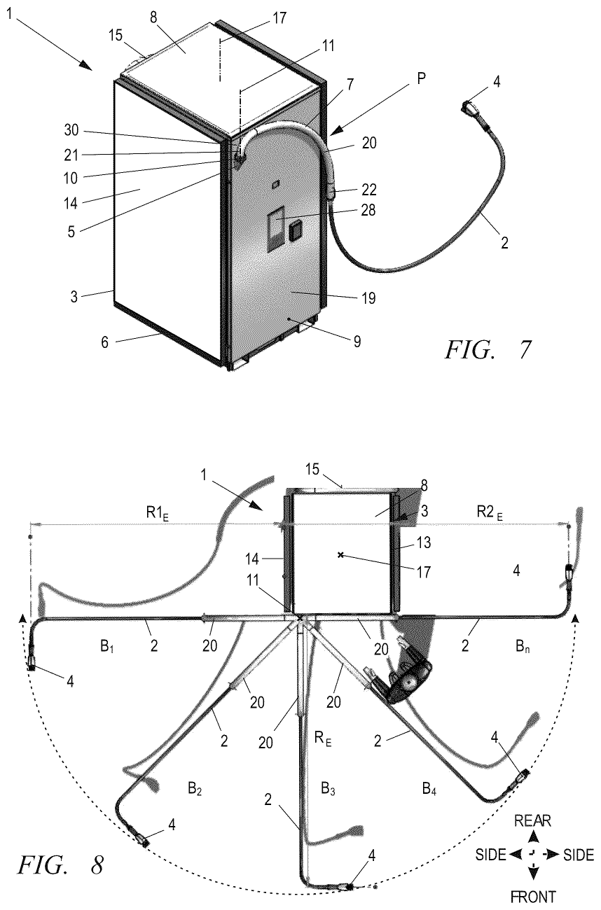

In the exemplary embodiment according to FIG. 5 to FIG. 8, the cable holder 20 is also shown in a parking position P on the front wall 9 of the charging post 1. The same parts as in FIGS. 1 to 4 are marked with the same reference signs. In contrast to FIG. 1, the cable outlet 5 is provided in an upper corner 30 of the housing wall 19 of the charging post 1. The upper corner 30 is positioned adjacent to an outer wall 14 at a distance a below the roof section 8 of the charging post 1. The design of the cable holder 20 and its length K is provided in such a manner that, in the parking position P shown, the cable holder 20 and the charging cable do not protrude beyond the outer walls 13, 14 of the charging post 1. In a top view of the front wall 9 of the charging post 1, the cable holder 20 and the charging cable 2 are positioned within the contour of the housing 3 of the charging post 1 in front of the front wall 9 in the parking position P. The pivotability of the cable holder 20 on the support 10 about the upright pivot axis 11 ensures a long range in an operating position Bₙ of the cable holder 20. Such range R1_{E} is greater in the operating position B1 on one outer wall 14 of the charging post 1 than the range R2_{E} in the operating position n on the other outer wall 13 of the charging post 1. As shown in FIG. 7, the range in the operating position Bₙ is substantially defined by the section of the charging cable 2 hanging freely from the end 22 of the cable holder 20. Nevertheless, a large range for the charging cable 2 with the charging plug 4 is ensured in a semicircle with the radius RE about the pivot axis 11.

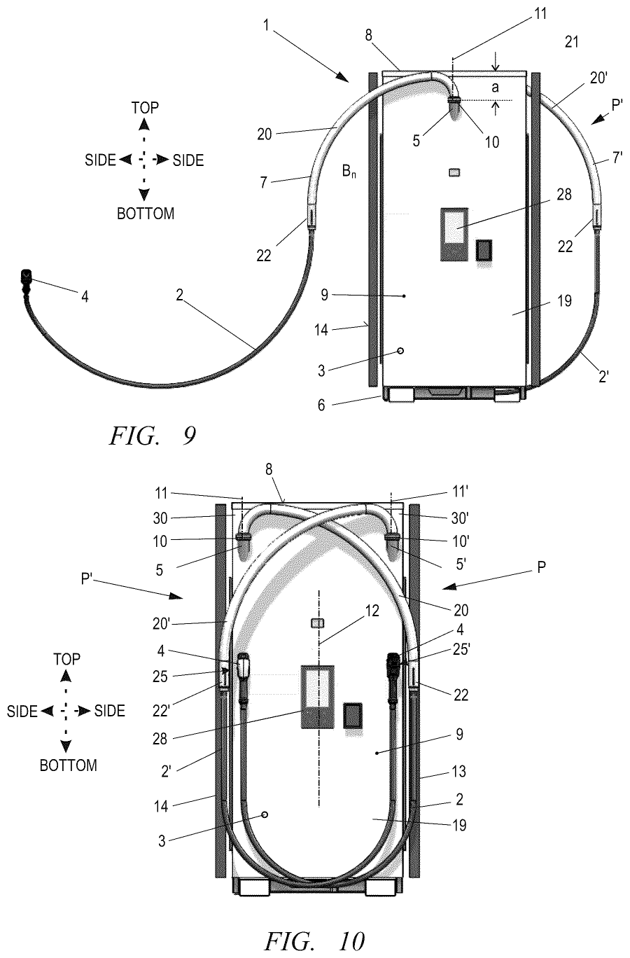

In the exemplary embodiment according to FIG. 9, a charging post 1 is shown, whose basic structure corresponds to the charging post 1 according to FIG. 1. The same parts as in FIGS. 1 to 8 are marked with the same reference signs. In contrast to the charging post 1 according to FIG. 1, the charging post 1 according to FIG. 9 has a cable outlet 5 with a support 10 for the cable holder 20 both on the front housing wall 19 and on the rear wall 15. Both on the front housing wall 19 and on the rear wall 15, the cable outlet 5 can be arranged centrally at a distance a below the roof section 8. Other placements of the cable outlet 5 on the housing 3 can be advantageous. On the front housing wall 19, the front wall 9, this results in a range for the charging cable 2/its charging plug 4 in a semicircle with the radius R M, in accordance with the presentation in FIG. 4. At the rear housing wall 19, the rear wall 15 of the charging post 1, this results in a range for the charging cable 2/its charging plug 4 in a semicircle with the radius RR in the same manner, corresponding to the dotted line representation in FIG. 4. The respective semicircle arises based on the pivotability of the cable holder 20 about the upright pivot axis 11.

In the exemplary embodiment according to FIG. 10, two cable outlets 5 and 5′ are provided on the charging post 1, both of are in each case arranged on the front housing wall 19 in an upper corner 30, 30′ in each case. The basic structure corresponds to the charging post according to the exemplary embodiment of FIG. 1 to FIG. 8, which is why the same reference signs are used for identical parts. A support 10, 10′ is assigned to each of the cable outlets 5, 5′ provided in the exemplary embodiment according to FIG. 10. Preferably, the support 10, 10′ is designed directly on the cable outlet 5, 5′, in particular in one piece with it. In this exemplary embodiment—as in all other exemplary embodiments—it can also be expedient to design the support 10 on the cable outlet 5 as a swivel joint or to equip it with a swivel joint. The support 10 and the cable outlet 5 can expediently be designed in one piece. The swivel joint can be firmly connected to the cable holder 20 and/or to the support 10.

As shown in the front view of the charging post 1 according to FIG. 10, the cable holders 20, 20′ can be pivoted up to the front housing wall 19, the front wall 9, in a parking position P, P′. The cable holder 20, which is pivotably held in the first corner 30, ends at the outer wall 13 of the housing 3 of the charging post 1. The free charging cable 2 is guided in a U-shaped curve to the opposite outer wall 14 and the charging plug 4 is hooked into a plug holder 25.

The cable holder 20′, which is pivotably held at the other cable outlet 5′ in the other corner 30′, is also pivoted towards the front housing wall 19 in its parking position P′ and ends at the outer wall 14 of the charging post 1. The free charging cable 2 extending from the end of the cable holder 20 to the charging plug 4 is guided in a U-shaped curve to the opposite outer wall 14 and the charging plug 4 is hooked into a plug holder 25′. In the parking position P, P′, the two cable holders 20, 20′ cross one another, as shown in the top view of the front housing wall 19 according to FIG. 10.

It can also be expedient to provide the parking positions P, P′ shown in FIG. 11, in which the cable holders 20, 20′ project forward at an angle from the front housing wall 19. The same parts as in the exemplary embodiments in FIGS. 1 to 10 are marked with the same reference signs. In the parking positions P, P′ shown in FIG. 11, the two charging cables 2, 2′ can be used independently of one another from the parking position. Here as well, the length of the free charging cable section is preferably dimensioned in such a manner that the charging cable 2 runs from the free end of the cable holder 20, 20′ to the hooked-in charging plug 4 without contact with the ground when the charging plug 4 is hooked into the plug holder 25.

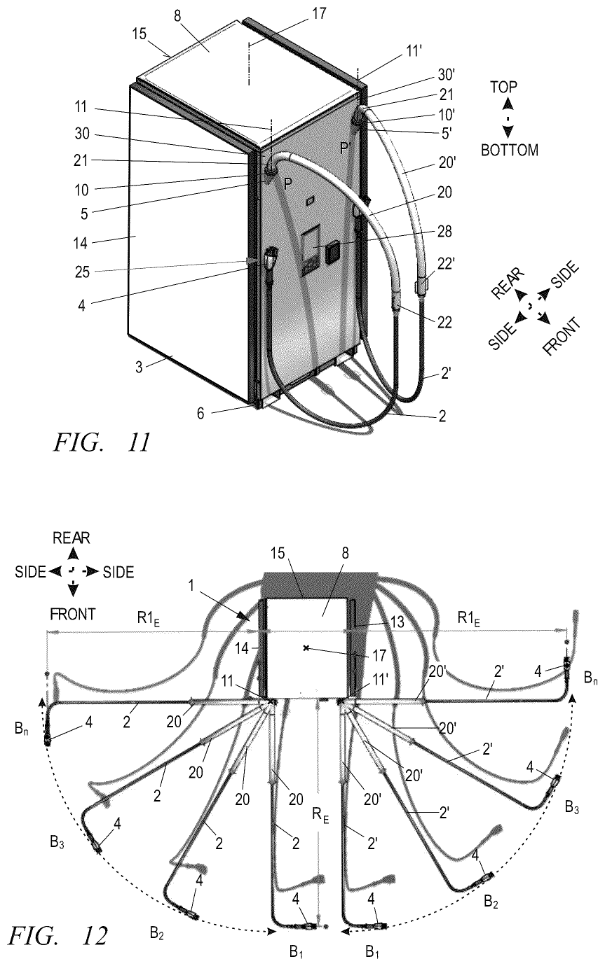

In FIG. 11, the ranges of the charging cables 2, 2′ are shown schematically in the top view of the charging post 1. The cable holders 20, 20′ can be pivoted about the upright pivot axes 11, 11′ in an angle range from 0° to 170° and more. In principle, each charging cable 2, 2′ has a large number of possible operating positions B₁, B₂, B₃, B₄ . . . Bₙ. The minimum possible range of the charging cable 2/2′ corresponds to at least a quarter circle about the pivot axis 11, 11′. For example, if the charging cable 2 is in the operating position B₃, the possible range of the charging cable 2′ is extended to 155° according to the top view in FIG. 12.

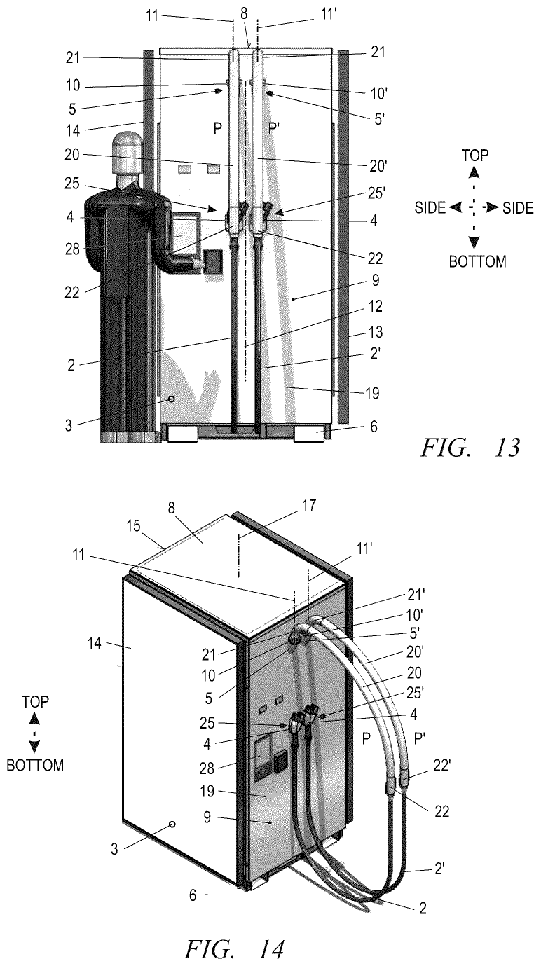

In the exemplary embodiments according to FIG. 13 to FIG. 16, the same parts as in FIGS. 1 to 12 are provided with the same reference signs. The charging posts 1 shown in FIG. 13 to FIG. 16 have a plurality of cable outlets 5, 5′ on a charging post 1. In contrast to the exemplary embodiments according to FIG. 10 to FIG. 12, the cable outlets 5, 5′ are positioned approximately centrally on the front housing wall 19. As FIG. 13 shows, the cable outlets 5, 5′ are positioned on both sides of the longitudinal center axis 12 of the front housing wall 19, the front wall 9. The cable outlets 5, 5′ correspond in their design to the representations shown in the exemplary embodiment according to FIG. 1 to FIG. 12. In the parking positions P, P′ in accordance with FIG. 13 and FIG. 14, the cable holders 20, 20′ protrude forwards at an angle from the front housing wall 19. The angle is preferably 90°. The connector holders 25, 25′ provided on the front housing wall are preferably at the same height level as the ends 22, 22′ of the cable holders 20, 20′.

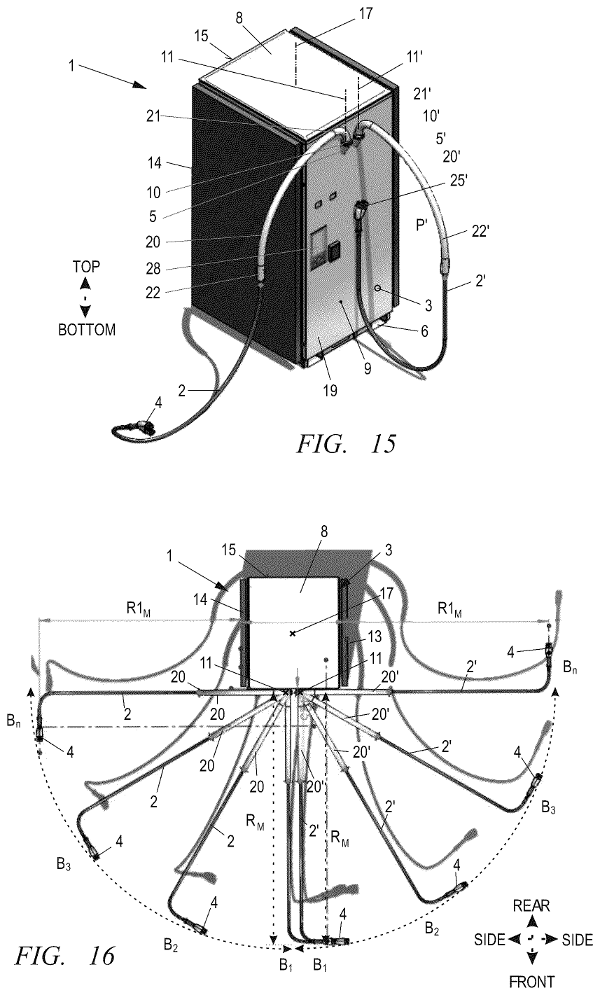

The charging cables 2, 2′ can be used independently of one another, as shown in FIG. 15. Based on the pivotability of the cable holders 20, 20′ about the pivot axes 11, 11′, both charging cables 2, 2′/their charging plugs 4 have a range in a quarter circle with the radius R M, as shown in the top view according to FIG. 16. The quarter circle of the range of the charging plug 4 can be extended depending on the operating position B₁, B₂, B₃, B₄ . . . Bₙ of the respective other cable holder 20, 20′. For example, if the charging cable 2′/the cable holder 20′ is in the operating position B₂, the possible pivot angle of the other charging cable 2 increases to a circular angle of approximately 125°.

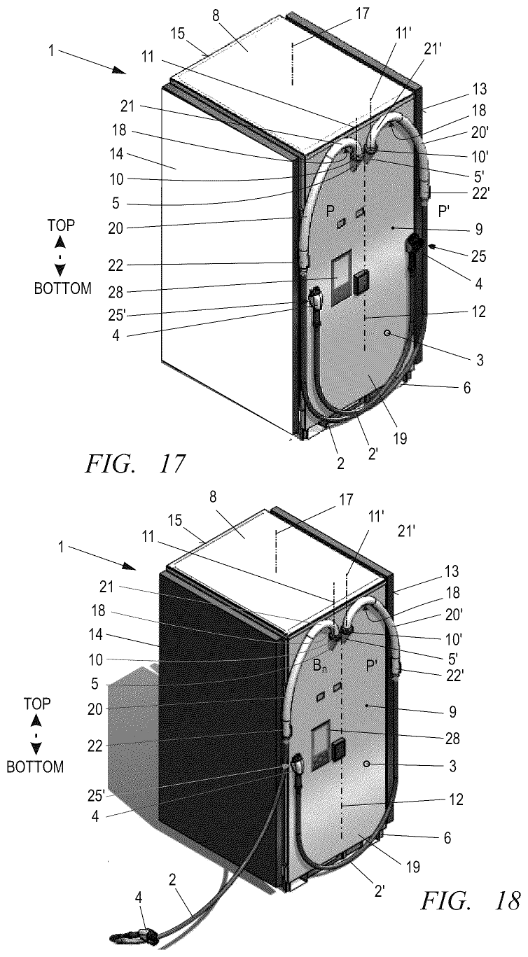

In the exemplary embodiment according to FIG. 17 to FIG. 20, the housing 3 of the charging post 1 has cable outlets 5, 5′ in an arrangement corresponding to FIG. 13. The same parts as in the exemplary embodiments in FIGS. 1 to 16 are marked with the same reference signs. In contrast to the exemplary embodiment according to FIGS. 13 to 16, the cable holder 20, 20′ in FIGS. 17 to 20 is designed in such a manner that in the parking position P, P′ shown in FIG. 17—seen in top view of the front housing wall 19—it does not protrude beyond the outer walls 13, 14 of the charging post 1. The cable holder 20 thus runs from the longitudinal center axis 12 in a curve to the outer wall 14, wherein the end 22 of the cable holder 20 ends at the outer wall 14 of the housing 3. The free charging cable section exiting the end 22 of the cable holder 20 is guided in a curve to the opposite outer wall 13 and held with its charging plug 4 in a plug holder 25. The plug holder 25 is provided adjacent to the opposite outer wall 13 of the housing 3 on the front housing wall 19. The plug holder 25 is positioned approximately at the height level of the end 22 of the cable holder 20.

The cable holder 20′, whose end 22′ ends at the outer wall 13 of the housing 3, is designed accordingly. The free charging cable section of the charging cable 2′ exits the end 22′ of the cable holder 20′ and is guided in a U-shaped curve to a plug holder 25′. The plug holder 25′ is positioned approximately at the height level of the end 22′ of the cable holder 20′ and receives the charging plug 4 of the charging cable 2′. The length of the free charging cable section is dimensioned in each case such that the charging cable 2, 2′ is not in contact with the ground.

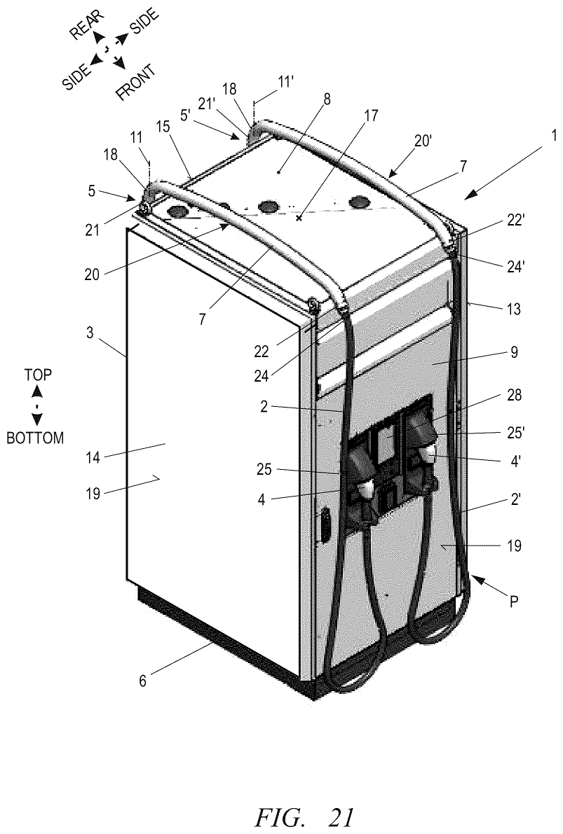

The charging cables 2, 2′ can be used independently of one another, wherein their range corresponds approximately to a quarter circle with a radius R1_{M}/R2_{M}, as shown in FIG. 20. Based on the central arrangement of the cable outlets 5, 5′, the range R1 and R2 next to the outer walls 13, 14 of the charging post 1 is the same. The pivotability of the cable holders 20, 20′ about the upright pivot axes 11, 11′ can influence one another. For example, if the cable holder 20′ is in an operating position B₃, the cable holder 20 can be pivoted about its pivot axis 11 over a pivot angle of approximately 150°, by which its range extends accordingly.

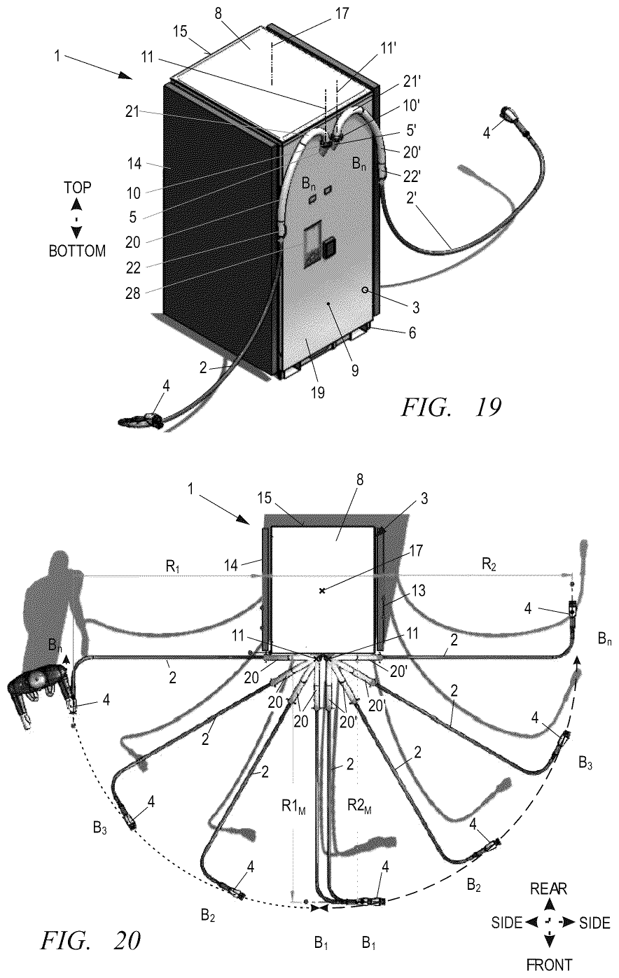

The charging cables 2, 2′ can be used independently of one another. As FIG. 18 shows, the cable holder 20′ is in the parking position P′ while the other cable holder 20 is in an operating position Bₙ and can be used to charge a mobile energy storage system. Simultaneous use of the charging cables 2, 2′ is also possible, as FIG. 19 shows.

FIGS. 21 to 26 show a further exemplary embodiment of a charging post 1. The same parts as in the exemplary embodiments in FIGS. 1 to 20 are provided with the same reference signs in FIGS. 21 to 26.

The charging post 1 has a housing 3 with a pedestal section 6 and a roof section 8. The housing 3 of the charging post 1 has a front housing wall 19, which is preferably designed as a front wall 9. Further housing walls as outer walls 13 and 14 adjoin the front housing wall 19, in particular on its longitudinal sides, which are substantially at an angle, in particular at a right angle to the front housing wall 19/the front wall 9. The housing 3 is closed off by a rear housing wall, which forms a rear wall 15 (FIG. 3).

In this exemplary embodiment, two cable outlets 5, 5′ are provided on the rear wall 15, wherein one cable outlet 5 is provided in an upper corner 30 in the region of the outer wall 13 and the roof section 8, and one cable outlet 5′ is provided in an upper corner 30′ in the region of the other outer wall 14 and the roof section 8.

Each cable outlet 5, 5′ is positioned at a distance a below the roof section 8. The cable outlet 5, 5′ is positioned with its outlet opening 23 facing the plane 33 of the roof section 8. The charging cable 2 is guided out of the cable outlet 5, 5′ into the cable holder 20/20′ in the direction of the plane 33 of the roof section 8. Expediently, the cable holder 20, 20′ is held on the support 10 about a vertical pivot axis 11, 11′, wherein it is expedient to design the support 10/10′ itself as a swivel joint. The support 10 and the cable outlet 5 are advantageously designed in one piece. In particular, the swivel joint is firmly connected to the cable holder 20, 20′ and/or to the support 10, 10′.

The cable holder 20 has a first end 21 and a second end 22. The cable holder 20 is advantageously a cable tube 7, which has a curved shape between its ends over its length K. In particular, the cable holder 20/the cable tube 7 is curved in a C-shape.

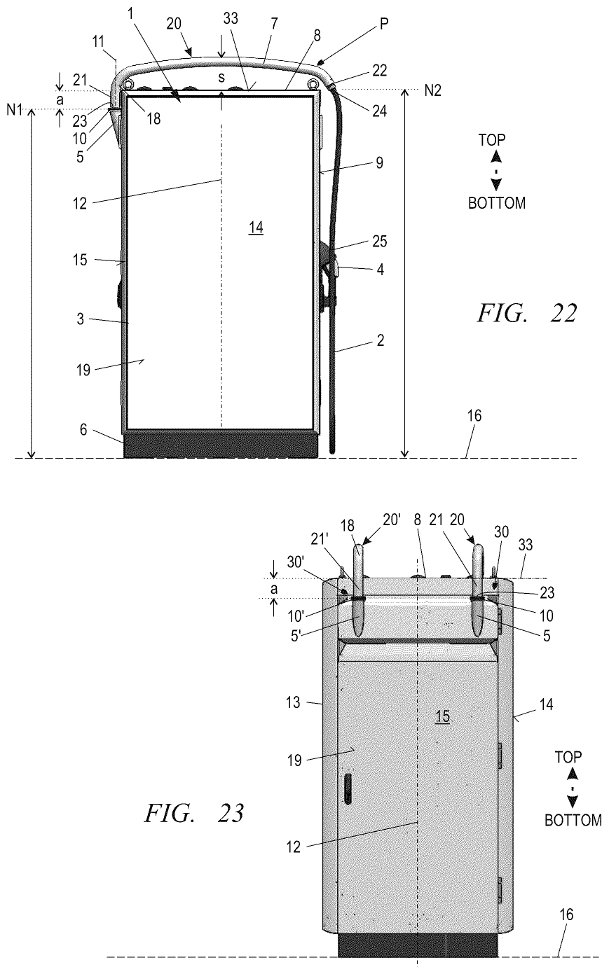

The arrangement of the cable holder 20 on the charging post 1 is provided in such a manner that its first end 21, which is pivotably held on the support 10, is positioned at a first height level N1. The second end 22 of the cable holder 20 is positioned at a second height level N2. In the exemplary embodiment shown, as FIG. 22 in particular shows, the first height level N1 is lower than the second height level N2. As FIG. 22 shows, the first height level N1 is below the plane 33 of the roof section 8 and the second height level N2 is above the plane 33 of the roof section 8.

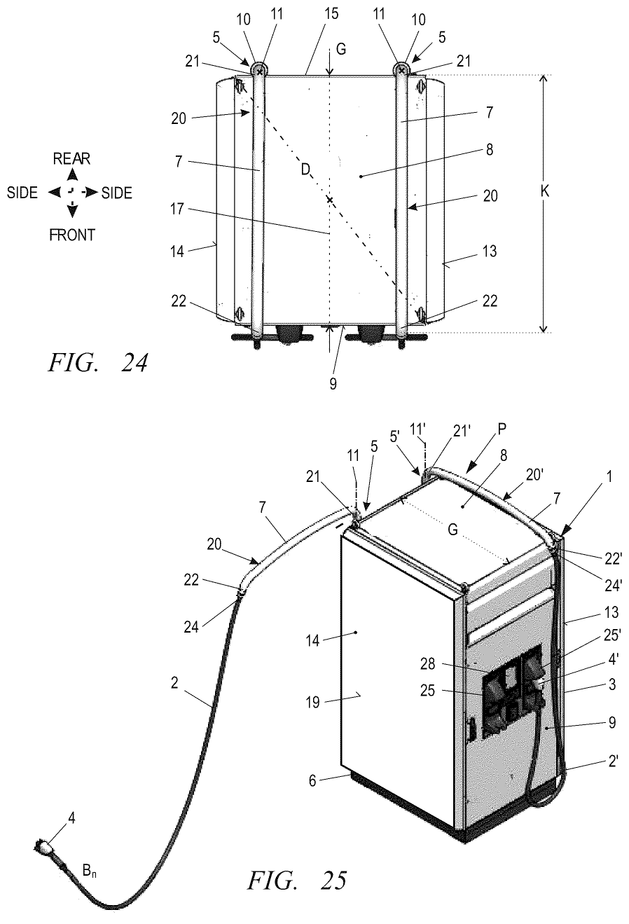

The cable tube 7 forming the cable holder 20 has a length K (FIG. 24) that is greater than the distance G between the front wall 9 and the rear wall 15 of the housing 3. In particular, the length K of the cable tube 7 is designed in such a manner that it corresponds to the length of the diagonal D of the roof section 8 of the housing 3. Preferably, the length K of the cable tube 7 is 3% to 10% longer than the diagonal D of the roof section 8.

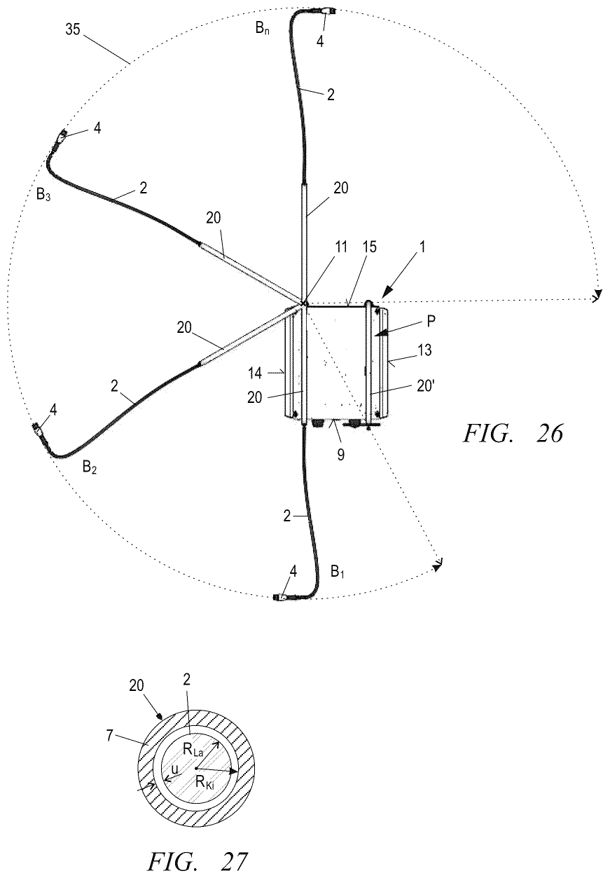

The cable holder 20 has a parking position P (FIG. 21) and a plurality of operating positions B1, B2, B3, . . . . Bn, as shown in FIG. 26. The cable holder 20 is positioned at a preferably short distance s above the roof section 8. The cable holder 20 can be pivoted about the pivot axis 11 on the rear side 15 of the housing 3 by a pivot angle of up to 360°. FIG. 26 shows a possible pivot angle 35 of almost 300°, since the further cable holder 20′ is in a parking position P. A vehicle to be charged can be positioned and charged in almost any orientation in relation to the charging post 1.

In its parking position in accordance with the representation in FIG. 21 to FIG. 24, the cable holder 20 extends over the roof section 8 of the housing 3. In this parking position, the horizontal part of the cable holder 20 is positioned at a maximum distance s above the roof section 8 of the housing 3. The distance s is dimensioned such that the cable holder 20/20′ can pivot about its respective pivot axis 11, 11′ above the roof section 8. It can be expedient to select the maximum distance s such that it corresponds to 3% to 15% of the length K of the cable holder. Advantageously, the maximum distance s of the curved cable holder is approximately 10% of the length K of the cable holder. In the parking position, the cable holder 20 does not protrude beyond the outer walls 13, 14 of the housing 3 of the charging post 1. In the parking position, the horizontal part of the cable holder 20 is parallel to the plane defined by an outer wall 13/14.

The cable outlet 5 with the support 10 is provided on the rear wall 15 of the housing 3. The first end 21 of the cable holder 20 is held on the support 10 in the region of the rear wall 15 so that it can rotate about the upright pivot axis 11. In a parking position P of the cable holder 20, the second end 22 of the cable holder 20 ends in a region in front of the front wall 9 of the housing 3. As shown in FIG. 22, the second end 22 of the cable holder 20 ends at the plane 33 of the roof section 8. In particular, the second end 22 of the cable holder 20 is positioned above the plane 33 of the roof section 8. The first end 21 of the cable holder 20 is positioned at a first height level N1 and the second end 22 of the cable holder 20 is positioned at a second height level N2. In an expedient design, the first height level N1 is lower than the second height level N2.

The designs of the cable outlet 5, the support 10, the cable holder 20, the cable tube 7, the guiding of the charging cable 2 at the cable outlet 5, the distance a of the cable outlet to the roof section of the charging post and similar designs shown for the individual exemplary embodiments FIG. 1 to FIG. 26 are not limited to the respective exemplary embodiment shown, but are readily transferable to any other exemplary embodiments.

1.-16. (canceled)

17. A charging post, comprising:
a housing (3), including
a front housing wall (19),
outer walls (13, 14) adjoining longitudinal sides of the front housing wall (19),
a rear wall (15), and
a roof section (8);
a charging cable (2) for connecting the charging post to a mobile energy storage system, the charging cable (2) being guided out of the housing (3) of the charging post (1) via a cable outlet (5); and
a charging plug (4) arranged at an end of the charging cable (2),
wherein the housing (3) further includes a support (10) for a cable holder (20),
wherein the cable holder (20) is held on the support (10) so as to be pivotable about an upright pivot axis (11),
wherein a length (K) of the cable holder (20) is less than a length (L) of the charging cable (2) from the cable outlet (5) to the charging plug (4),
wherein the cable holder (20) is designed to be stiff,
wherein the charging cable (2) is guided and stiffened by the cable holder (20) in a charging cable section (L1),
wherein the cable outlet (5) is provided on the front housing wall (19), on one of the outer walls (13, 14), or on the rear wall (15) of the housing (3),
wherein the cable outlet (5) is positioned with an outlet opening (23) facing a plane (33) of the roof section (8) of the charging post (1), and
wherein the cable outlet (5) is designed as the support (10) for the cable holder (20).

18. The charging post according to claim 17,
wherein the cable holder (20) has a first end (21) and a second end (22), and
wherein the first end (21) of the cable holder (20) is held on the support (10) so as to be pivotable about the upright pivot axis (11).

19. The charging post according to claim 17,
wherein the cable holder (20) is C-shaped.

20. The charging post according to claim 17,
wherein the cable holder (20) is a rigid cable tube (7), in which the charging cable (2) is guided with radial clearance (u).

21. The charging post according to claim 17,
wherein the charging post (1) has a pedestal section (6), and
wherein the cable outlet (5) with the support (10) is positioned closer to the roof section (8) than to the pedestal section (6) of the housing (3).

22. The charging post according to claim 17,
wherein the cable outlet (5) with the support (10) is positioned on a longitudinal center axis (12) of the front housing wall (19), one of the outer walls (13, 14), or the rear wall (15), or
wherein the cable outlet (5) with the support (10) is positioned in an upper corner (30, 30′) of the front housing wall (19), one of the outer walls (13, 14), or the rear wall (15).

23. The charging post according to claim 17,
wherein the cable holder (20) can be pivoted by up to 180° about the upright pivot axis (11) of the support (10).

24. The charging post according to claim 17,
wherein the cable holder (20) has a parking position (P) and a plurality of operating positions (B1, B2, B3, B4, . . . Bn), and
wherein the cable holder (20) does not protrude beyond the outer walls (13, 14) of the housing (3) of the charging post (1) in the parking position (P).

25. The charging post according to claim 17,
wherein the cable holder (20) has a parking position (P) and a plurality of operating positions (B1, B2, B3, B4, . . . Bn), and
wherein the cable holder (20) does not protrude beyond the outer walls (13, 14) of the housing (3) of the charging post (1) in all operating positions (B1, B2, B3, B4, Bn).

26. The charging post according to claim 17,
wherein the cable holder (20) has a parking position (P) and a plurality of operating positions (B1, B2, B3, B4, . . . Bn), and
wherein in the parking position (P) the cable holder (20) extends over the roof section (8) of the housing (3) and does not protrude beyond the outer walls (13, 14) of the housing (3) of the charging post (1).

27. The charging post according to claim 26,
wherein the cable outlet (5) is provided with the support (10) on the rear wall (15) of the housing (3),
wherein a first end (21) of the cable holder (20) is held on the support (10) in a region of the rear wall (15) so as to be rotatable about the upright pivot axis (11), and
wherein, in the parking position (P) of the cable holder (20), a second end (22) of the cable holder (20) is arranged in a region in front of the front housing wall (19) of the housing (3).

28. The charging post according to claim 27,
wherein the second end (22) of the cable holder (20) is arranged at the plane (33) of the roof section (8).

29. The charging post according to claim 27,
wherein the first end (21) is arranged at a first height level (N1), and
wherein the second end (22) is arranged at a second height level (N2), and
wherein the first height level (N1) is lower than the second height level (N2).

30. The charging post according to claim 17,
wherein the cable holder (20) has
a first end (21) at a first height level (N1) and
a second end (22) at a second height level (N2), and
wherein the second height level (N2) is lower than the first height level (N1).

31. The charging post according to claim 17,
wherein one or more further cable outlets (5′) for further charging cables (2′) are provided on the front housing wall (19), one of the outer walls (13, 14), or the rear wall (15).

32. The charging post according to claim 17,
wherein one or more further cable outlets (5′) for further charging cables (2′) are provided on the front housing wall (19), one of the outer walls (13, 14), or the rear wall (15), and
wherein the cable outlet (5) and the one or more further cable outlets (5′) are positioned at a common height.
